(19) United States
(12) Patent Application Publication
(10) Pub. No.: US 2025/0240582 A1
(43) Pub. Date: Jul. 24, 2025

(54) REMOVABLE MICROPHONE MODULE FOR AN EAR-WORN DEVICE

(71) Applicant: Starkey Laboratories, Inc., Eden Prairie, MN (US)

(72) Inventors: Kristi Khondkar, Eden Prairie, MN (US); Ryan Chester, Bloomington, MN (US); Ganesh Borra, Plymouth, MN (US); Joshua Elliot Braband, Eden Prairie, MN (US); Daniel Smieja, Minneapolis, MN (US)

(21) Appl. No.: 18/987,761

(22) Filed: Dec. 19, 2024

Related U.S. Application Data
(60) Provisional application No. 63/623,056, filed on Jan. 19, 2024.

(51) Int. Cl. H04R 25/00

(52) U.S. Cl. CPC H04R 25/604; H04R 25/405; H04R 25/609; H04R 25/65

(57) ABSTRACT

Various ear-worn devices are provided. An ear-worn device can include a housing. The housing can include a microphone module and a body module. The microphone module can include a first microphone adjacent to a first microphone port. The microphone module can define a first housing inlet and a first acoustic channel. The first acoustic channel can include a first end at the first housing inlet and a second end at the first microphone port. The microphone module can be removably coupled to the body module.

### RELATED APPLICATIONS

This application claims the benefit of U.S. Provisional Application No. 63/623,056, filed Jan. 19, 2024, the content of which is incorporated herein by reference in its entirety.

### FIELD

Embodiments herein relate to ear-worn devices and more particularly to an ear-worn device with a completely removable microphone module having a consistent acoustic path.

### BACKGROUND

Hearing devices are configured to provide audio input to the ears of a user. Some examples of hearing devices are headsets, hearing aids, speakers, cochlear implants, bone conduction devices, and personal listening devices. Hearing devices often include a battery, a microphone and associated electronic components. In many cases, if a microphone becomes unusable, the entire device becomes unusable.

### SUMMARY

In an embodiment, a ear-worn device is provided. The ear-worn device can include a housing. The housing can include a microphone module and a body module. The microphone module includes a first microphone adjacent to a first microphone port. The microphone module defines a first housing inlet and a first acoustic channel having a first end at the first housing inlet and a second end at the first microphone port. The microphone module is removably coupled to the body module.

In an embodiment, the microphone module further defines a second housing inlet. The first housing inlet and the second housing inlet define a pass-through channel in the microphone module. The pass-through channel includes a first inlet channel and a second inlet channel. The pass-through channel is a portion of the first acoustic channel.

In an embodiment, the first acoustic channel includes a combined path channel that extends substantially perpendicular to the pass-through channel.

In an embodiment, the first acoustic channel is defined entirely within the microphone module.

In an embodiment, at least a portion of the first acoustic channel is defined by the microphone module from the first inlet opening to the first microphone port. A second portion of the first acoustic channel is defined by the body module.

In an embodiment, the microphone module includes a microphone module case, and the first acoustic channel is defined entirely by the microphone module case.

In an embodiment, the microphone module includes a microphone module case and a gasket disposed within the microphone module case. The first acoustic channel is defined by the microphone module case and the gasket.

In an embodiment, the microphone module further includes a circuit board. The first microphone is coupled to the circuit board.

In an embodiment, the microphone module further includes a connector electrically coupling the circuit board with an electronics package disposed within the body module.

In an embodiment, the connector is rigidly attached to the microphone module.

In an embodiment, the microphone module is removably coupled with the body module via the connector, such that the connecter interfaces with a component of the body module.

In an embodiment, the ear-worn device can further include a non-volatile memory element coupled to the circuit board.

In an embodiment, the microphone module further includes a second microphone adjacent to a second microphone port. The microphone module defines a third housing inlet, a fourth housing inlet and a second acoustic channel extending from the third housing inlet and the fourth housing inlet to the second microphone port.

In an embodiment, the third housing inlet and the fourth housing inlet define a second pass-through channel in the microphone module. The second pass-through channel includes a third inlet channel and a fourth inlet channel. The second pass-through channel is a portion of the second acoustic channel.

In an embodiment, the first pass-through channel and the second pass-through channel are both substantially straight/linear. The first acoustic channel includes a combined path channel that extends substantially perpendicular to the first pass-through channel, and the second acoustic channel includes a combined path channel that extends substantially perpendicular to the second pass-through channel.

In an embodiment, the microphone module is removably coupled with the body module via a connection selected from the group consisting of a snap fit, a compression fit, and a mechanical fastener.

In an embodiment, a ear-worn device system is provided. The ear-worn device can include a housing. The housing can include a first microphone module and a body module. The first microphone module includes a first microphone adjacent to a first microphone port. The first microphone module defines a first housing inlet and a first acoustic channel having a first end at the first housing inlet and a second end at the first microphone port. The first microphone module is removably coupled to the body module. The system can further include a second microphone module. The second microphone module includes a first microphone adjacent to a first microphone port. The second microphone module defines a first housing inlet and a second acoustic channel having a first end at the first housing inlet and a second end at the first microphone port. The second microphone module is configured to be removably coupled to the body module to replace the first microphone module.

In an embodiment, a method of assembling an ear-worn device is provided. The method can include coupling a first microphone module to a body module via a removeable coupling to assemble a housing. The first microphone module includes a first microphone adjacent to a first microphone port. The first microphone module defines a first housing inlet and a first acoustic channel having a first end at the first housing inlet and a second end at the first microphone port. The method can include uncoupling the first microphone module from the body module, and coupling a second microphone module to the body module via a removeable coupling to assemble the housing. The second microphone module includes a first microphone adjacent to a first microphone port. The second microphone module defines a first housing inlet and a first acoustic channel having a first end at the first housing inlet and a second end at the first microphone port.

In an embodiment, the second microphone module includes at least one element that the first microphone module does not. The at least one element is selected from the group can include: a telecoil, an accelerometer, an inertial measurement unit, and a sensor.

In an embodiment, the second microphone module includes a function set that is identical to a function set of the first microphone module.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of an ear-worn device in accordance with various embodiments herein.

FIG. 2 is an exploded view of an ear-worn device system in accordance with various embodiments herein.

FIG. 3 is a cross-section view of an ear-worn device in accordance with various embodiments herein.

FIG. 4 is a side view of a microphone module in accordance with various embodiments herein.

FIG. 5 is a cross-sectional view of the microphone module of FIG. 4, in accordance with various embodiments herein.

FIG. 6 is an exploded view of the microphone module of FIG. 4, in accordance with various embodiments herein.

FIG. 7 is a schematic of an ear-worn device in accordance with various embodiments herein.

FIG. 8 is a cross-section view of an ear-worn device in accordance with various embodiments herein.

FIG. 9 is a schematic of an acoustic path within an ear-worn device in accordance with various embodiments herein.

FIG. 10 is a schematic of an acoustic path within an ear-worn device in accordance with various embodiments herein.

FIG. 11 is a flow chart depicting a method in accordance with various embodiments herein.

FIG. 12 is a flow chart depicting a method in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Various ear-worn devices, such as hearing aid assemblies, are provided herein. An ear-worn device can include a hearing aid assembly. Various embodiments of an ear-worn device with a removably coupled microphone module are provided herein. In various embodiments, the ear-worn device can be configured to rest against a user's outer ear. The device can include a housing. The housing can define one or more housing inlets. The ear-worn device contains an electronics assembly within the housing that includes at least one microphone inlet leading to at least one microphone. The ear-worn device has at least one acoustic passageway extending inward from the housing inlet to the microphone inlet. The acoustic passageway can include a trap portion.

Ear-worn devices can include a variety of devices or systems. In some embodiments, an ear-worn device can include a hearing aid assembly. The term “hearing aid assembly” as used herein shall refer to devices that can aid a person with impaired hearing. The term “hearing aid assembly” shall also refer to devices that can produce optimized or processed sound for persons with normal hearing. Hearing aid assemblies herein can include hearables (e.g., wearable earphones, headphones, earbuds, virtual reality headsets), hearing aids (e.g., hearing instruments), cochlear implants, and bone-conduction devices, for example. Hearing aid assemblies include, but are not limited to, behind-the-ear (BTE), in-the ear (ITE), in-the-canal (ITC), invisible-in-canal (IIC), receiver-in-canal (RIC), receiver in-the-ear (RITE) or completely-in-the-canal (CIC) type hearing aid assemblies or some combination of the above. In some embodiments, the hearing aid assemblies may comprise a contralateral routing of signal (CROS) or bilateral microphones with contralateral routing of signal (BiCROS) amplification system. In some embodiments herein, a hearing aid assembly may also take the form of a piece of jewelry, including the frames of glasses, which may be attached to the head on or about the ear. The structures and components described herein can also be used in an ear-wearable device that is not a hearing assistance device, such as a medical monitoring device.

The ear-worn devices can be configured to removably receive a microphone module. The microphone module can include a circuit board and some electrical components. In various embodiments, the microphone module can include one or more microphones, acoustic passages and ports, mechanical support structures for the microphone(s), and foreign material ingress protection means.

Incorporating these components into a removably connected microphone module can provide more consistent acoustic performance, which can allow for more consistent directional performance from device to device. These features in the microphone module can also provide a user with the ability to easily upgrade or add features to the device, such as where a replacement microphone module can have different components or features than a previous microphone module, allowing the user to add features or components without replacing the rest of the ear-worn device. Alternatively, a microphone module can be removed from a first body module and placed into a new body module, where the new body module includes different components or features than the previous body module. This approach can allow the user to upgrade the ear-worn device without needing to have an audiologist or other expert recalibrate the device.

An ear-worn device including a removeable microphone module can facilitate quick repair when a part is not functioning properly. In some cases, a portion of the microphone module can break or no longer function as intended. In such a case, the microphone module can be replaced with a new properly functioning microphone module to remedy the problem. In other cases, there can be a problem with the electronics within the main body module of the ear-worn device. In such a case, the microphone module can be uncoupled from the broken main body module and coupled to a new main body module. The new main body module can be the same as the previous main body module, or in other cases, the new main body module can have enhanced or additional features allowing the user to easily and quickly upgrade their device.

Embodiments provided herein allow for the microphone module or the body module to be replaced easily. In some embodiments, one of the module can be user replaced, such that a normal user of the ear-worn device could obtain a second body or microphone module to replace an existing body or microphone module. The user is able to switch out the old (first) module with a new (second) module at home without the need for assistance from a technician, audiologist or the manufacturer. In some embodiments, a trained technician or audiologist can replace one of the modules without the need for sending the device to the manufacturer for replacement. A trained technician or audiologist can be a person that has knowledge of how to fix or work on an ear-worn device but is not the user or the manufacturer of the device. In some scenarios, an ear-worn device can be sent to the original manufacturer for repair.

Embodiments of an ear-worn device provided herein can include various advantages over previous ear-worn devices. In some embodiments, the configuration of the ear-worn devices described herein can include improved consistency in acoustic path. The consistency of the acoustic path can reduce device to device variation and be more easily designed. Secondly, various embodiments can enable specialized manufacturing processes that can increase efficiency and decrease cost.

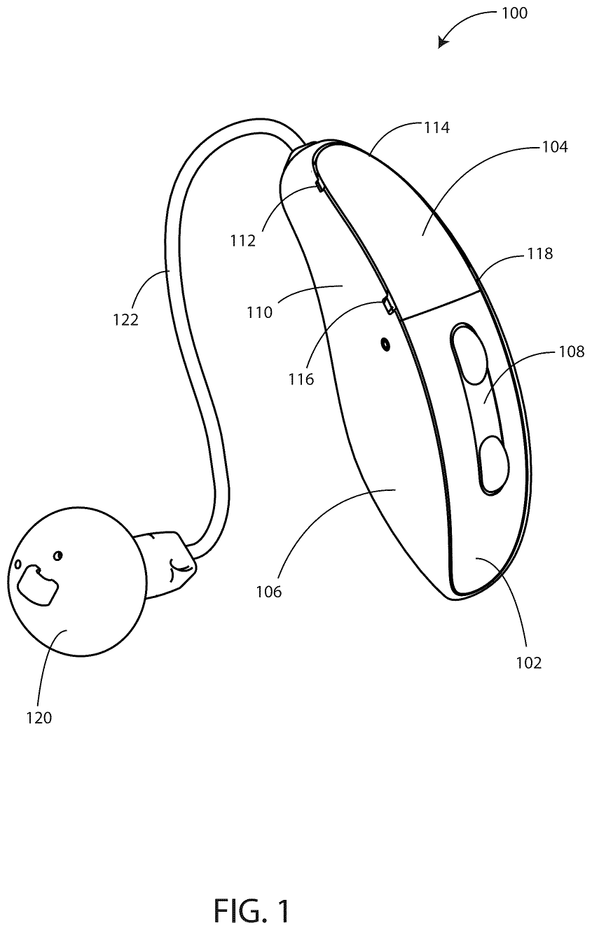

Referring now to FIG. 1, a perspective view of an ear-worn device is shown in accordance with various embodiments herein. The ear-worn device 100 in the embodiment of FIG. 1 is a behind-the-ear (BTE) type device and thus the components are housed behind the ear with a cable leading to an earbud designed to be placed within an car canal of a wearer. The ear-worn device 100 can include a housing 102. In various embodiments, the housing 102 is adapted to be worn on or behind an ear of a wearer. The housing 102 is configured to rest against a user's outer ear in a behind-the-ear orientation. The housing 102 can be manufactured utilizing any suitable technique or techniques, e.g., injection-molding, 3D printing, etc. The housing 102 can include any suitable material or materials, e.g., silicone, urethane, acrylates, flexible epoxy, acrylated urethane, and combinations thereof. In various embodiments, the housing 102 can include a microphone module 104 and a body module 106. In various embodiments, the microphone module 104 is removably attached to the body module 106 by means of any of a snap fit, press fit, a pin connection, a compression fit, a mechanical fastener, or the like.

In various embodiments, the ear-worn device 100 can include user input devices 108. In the example of FIG. 1, the user input devices 108 are disposed on the top of the body module 106 of the housing 102, but other placements are of the user input device are also possible. In various embodiments, the user input device 108 can include one or more, buttons, switches, or the like, such as a first button and a second button. For example, a volume up button and a volume down button can be included in the user input device. In various embodiments, the hearing aid user can interact with the user input device 108 (e.g., by pressing one or more buttons) to adjust the volume, change one or more settings, or turn the ear-worn device on or off.

In various embodiments, the housing 102 can define a body module cavity 110. The body module cavity 110 can be configured to hold one or more electronic components. The electronic components can be disposed in any suitable location or arrangement within the body module cavity 110. The ear-worn device 100 can include any suitable combination of electronic components as will be further described herein.

In various embodiments, the housing 102 can have a one or more inlets. The inlets are configured provide an entrance to a passageway from the ambient environment to the interior of the housing. In some embodiments, the one or more inlets are defined by the microphone module 104. In some embodiments, the one or more inlets are defined between the microphone module 104 and the body module 106. In the example of FIG. 1, the microphone module 104 defines a left front housing inlet 112, a right front housing inlet 114, a left back housing inlet 116, and a right back housing inlet 118. It should be noted that the housing 102 (e.g. the microphone module 104) can have any suitable number of inlets at any suitable location. In some embodiments, the housing 102 (e.g. the microphone module 104) can have greater than or equal to one, two, three, four, or five inlets.

In various embodiments, an exterior surface of the microphone module 104 defines a portion of the exterior surface of the housing 102 and an exterior surface of the body module 106 defines a portion of the exterior surface of the housing 102. In various embodiments, an exterior surface of the microphone module 104 and an exterior surface of the body module 106 define the entirety of the exterior surface of the housing 102. The microphone module 104 and the body module 106 are attached to form the housing 102.

In various embodiments, an interior surface of the microphone module 104 defines a portion of and interior cavity, such as to house an electronics package. In various embodiments, an interior surface of the body module 106 defines a portion of a body module cavity 110. In some embodiments, the interior cavity defined by the microphone module 104 is separated or isolated from the body module cavity 110.

In various embodiments, the microphone module 104 can include at least one microphone. In various embodiments, the microphone module 104 can include two microphones. In various embodiments, as will be discussed below, the microphone module 104 can define one or more acoustic channels. An acoustic channel can be a channel or path from the ambient environment to a microphone within the microphone module 104. In some embodiments, an acoustic channel can extend from one or more of the inlets 112, 114, 116, 118 to a microphone. In some embodiments, an acoustic channel extends from two of the inlets 112, 114, 116, 118 to a microphone.

The ear-worn device 100 can further include an earbud 120 configured to be worn in the ear canal of the user. Any suitable earbud 120 can be utilized with the ear-worn device 100. In some examples, the earbud 120 can be a custom-fit earmold or a dome style earbud that doesn't block the entire ear canal opening of the wearer. The earbud 120 can be operatively connected to the electronic components housed in body module cavity 110 using any suitable technique or techniques. The ear-worn device 100 can further include a cable 122 or connecting wire. The cable 122 can include one or more electrical conductors and provide electrical communication between components inside of the housing 102 and the earbud 120. In one or more embodiments, the earbud 120 can be operatively connected to the electronic components disposed within the housing 102 by a cable 122 forming a sound tube that extends between the earpiece and the housing 102.

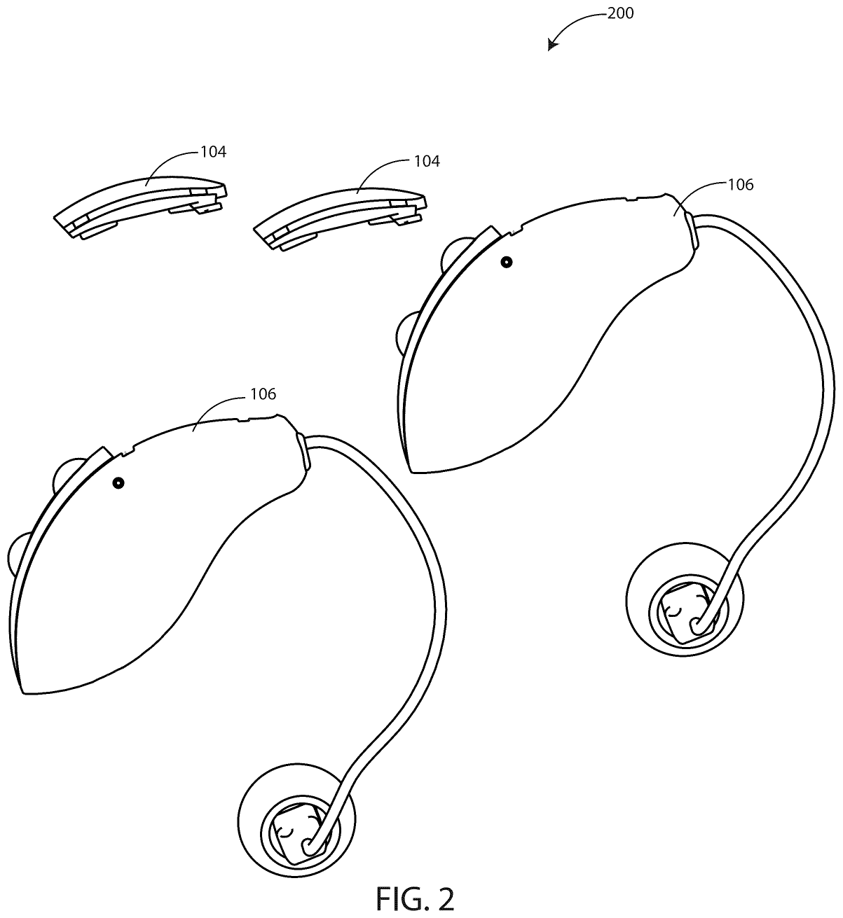

Referring now to FIG. 2, an exploded view of an ear-worn device system 200 is shown in accordance with various embodiments herein. FIG. 2 depicts a system that can include one or more microphone modules 104 and one or more body modules 106. FIG. 2 depicts a body module 106 with the microphone module 104 removed, allowing for attachment of either microphone module 104 with either body module 106.

In various embodiments, an ear-worn device 100 can include a microphone module 104 that is removable from the body module 106. In an embodiment, the microphone module 104 may be pulled out from or uncoupled from the top of the body module 106. After being uncoupled from the body module 106, microphone module 104 or the body module can be replaced.

In some embodiments, the system 200 can include one microphone module 104 and two body modules 106. In such a system, a user can keep or reuse the microphone module 104 with two different body modules. In some cases, the two different body modules 106 can be exactly the same. In such a case, a user might replace a first body module 106 with a second body module 106, such as to replace an old body module 106 with a new body module. If the first body module 106 is no longer functioning properly, a user can obtain a second body module and switch the microphone module 104 from being coupled to the first body module to being coupled to the second body module. As a result, the user can have a properly functioning ear-worn device without the need for replacing the microphone module. The user can also have a properly functioning ear-worn device 100 without the need for recalibration, if the microphone module includes a memory component as will be discussed below.

In some cases, the two different body modules 106 can be different from each other. In such a case, a user might want to upgrade or add certain features to his/her ear-worn device 100. In such a case, a user can obtain a first or new body module 106 that includes new or different features from the second or old body module and switch his/her microphone module 104 from being coupled to the first body module to being coupled with the second body module 106.

In some embodiments, the system 200 can include two microphone modules 104 and one body modules 106. In such a system, a user can keep or reuse the body module 106 with two different microphone modules 104. In some cases, the two different microphone modules 104 can be exactly the same. In such a case, a user might replace a first microphone module 104 with a second microphone module 104. If the first microphone module 104 is no longer functioning properly, a user can obtain a second microphone module 104 and switch the first microphone module 104 from being coupled to the body module 106 with the second microphone module 104. As a result, the user can have a properly functioning ear-worn device without the need for replacing the body module 106.

In some cases, the two different microphone modules 104 can be different from each other. In such a case, a user might want to upgrade or add certain features to his/her ear-worn device 100. In such a case, a user can obtain a second or new microphone module 104 that includes new or different features from the first or old microphone module, and switch his/her body module 106 from being coupled to the first microphone module 104 to being coupled with the second microphone module 104.

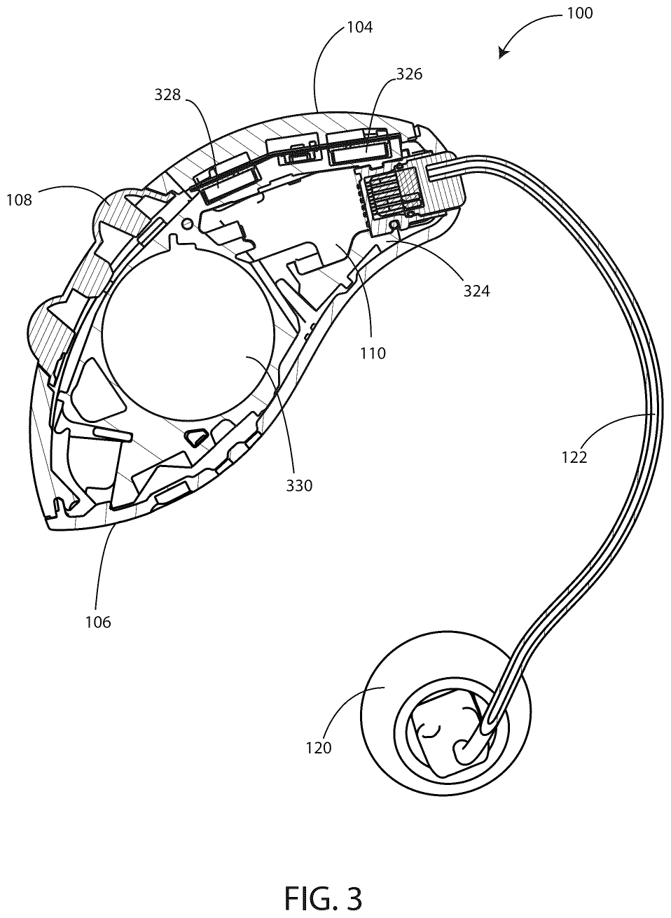

Referring now to FIG. 3, a cross sectional view of the ear-worn device of FIG. 1 is shown in accordance with various embodiments herein. The body module cavity 110 is defined between the microphone module 104 and the body module 106. The body module cavity 110 can contain electronics assembly 324. In various embodiments, the microphone module 104 can include a magnetoresistance (GMR) sensor, a telecoil, an accelerometer, or an inertial measurement unit.

In some embodiments, the microphone module 104 can include a single microphone, such as for omni-only use cases. In other embodiments, two or more microphones can be included to support directionality. In the example of FIG. 3, the electronics assembly 324 has a front microphone 326 and a back microphone 328. The front microphone 326 and the back microphone 328 are both disposed within the microphone module 104. The electronics assembly 324 can contain any suitable number of microphones. In some embodiments, the electronics assembly 324 can have greater than or equal to one, two, three, four, or five microphones. In some embodiments, a single microphone is present in the ear-worn device, such as where simplicity of the device or low-power consumption is an advantage. Electronics assembly 324 can include one or more electronic components. Electronics assembly 324 can include one or more additional electronic components, such as a battery 330. In various embodiments, the microphone module can be configured to store microphone calibration data, such as sensitivity and other data. Sensitivity is typically expressed as millivolts per Pascal (mV/Pa). In various embodiments, the microphone module can store the data specified in the Transducer Electronic Data Sheet (TEDS) method, defined by IEEE 1451, or other standards, using an EEPROM or a similar component.

In various embodiments, data can be stored on the EEPROM or other similar component according to IEEE 1451. In addition to sensitivity other data can also be stored. In some embodiments, date codes used to indicate when the mic module was manufactured and characterized can be stored. In some embodiments, data related to the manufacturer, version, or type of microphone module can be stored.

In some embodiments, the ear-worn device could use this stored data to indicate which parameters to load onto the ear-worn device during programming. This method supports updating parameters on an ear-worn device with regular software updates. It also has the advantage that if the EEPROM fails after the ear-worn device is programmed, the device would not fail.

In various embodiments, parameters that tell the ear-worn device how to condition the signal so that the ear-worn device performs as designed can be stored. In various embodiments, the parameters can always be read from the EEPROM or copied the first time it operates (boots-up), or at some prescribed condition that is met, such as when the ear-worn device is connected to fitting software.

Any suitable microphone or combination of microphones can be utilized. In one or more embodiments, the microphone can be selected to detect one or more audio signals and convert such signals to an electrical signal that is provided to a controller. In various embodiments, the ear-worn device 100 can have a controller with an analog-to-digital convertor that converts the electrical signal from the microphone to a digital signal.

In some embodiments, the microphones can be matched prior to assembly of the microphone module 104. In various embodiments, trimmable microphones can be incorporated into the microphone module 104 in a way that the microphones could be trimmed to match the desired sensitivity, phase, or group-delay characteristics. In various embodiments, transducer electronic data sheet can be utilized to carry the characteristics of the microphones.

In various embodiments, processing and memory components can be disposed within the housing 102. In some embodiments, both the microphone module 104 and the body module 106 include at least one of a processing component and the memory component.

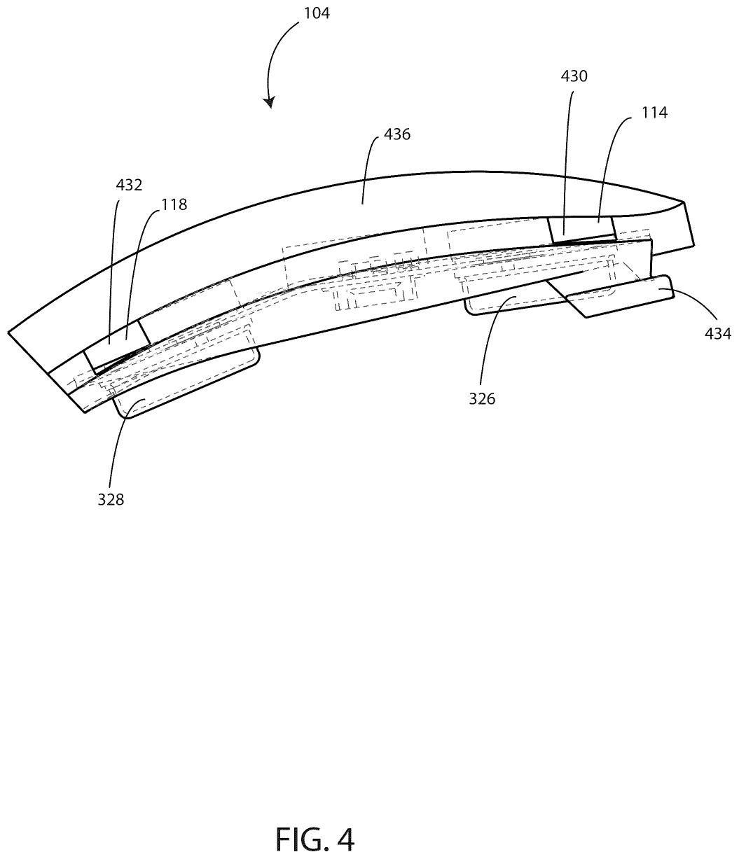

In reference now to FIG. 4, a side view of a microphone module is shown in accordance with various embodiments herein. As discussed above, the microphone module can define a right front housing inlet 114 and a right back housing inlet 118. The microphone module can further define a left front housing inlet 112 and a left back housing inlet 116 on the opposite side from the housing inlets 114, 118.

The microphone module 104 can define a first acoustic channel 430 that extends from at least one housing inlet to one of the microphones. In some embodiments, the first acoustic channel 430 extends from the left front housing inlet 112 and the right front housing inlet to the front microphone 326. In some embodiments, the second acoustic channel 432 extends from the left back housing inlet 116 and the right back housing inlet 118 to the back microphone 328. In various embodiments, the first acoustic channel 432 is isolated from the second acoustic channel 432.

In some embodiments, the first acoustic channel 430 is defined entirely by or within the microphone module 104. In some embodiments, the second acoustic channel 432 is defined entirely by or within the microphone module 104.

In some embodiments, a portion of the first acoustic channel 430 is defined by the microphone module 104 and a portion of the first acoustic channel 430 is defined by the body module 106. In some embodiments, a portion of the second acoustic channel 432 is defined by the microphone module 104 and a portion of the second acoustic channel 432 is defined by the body module 106.

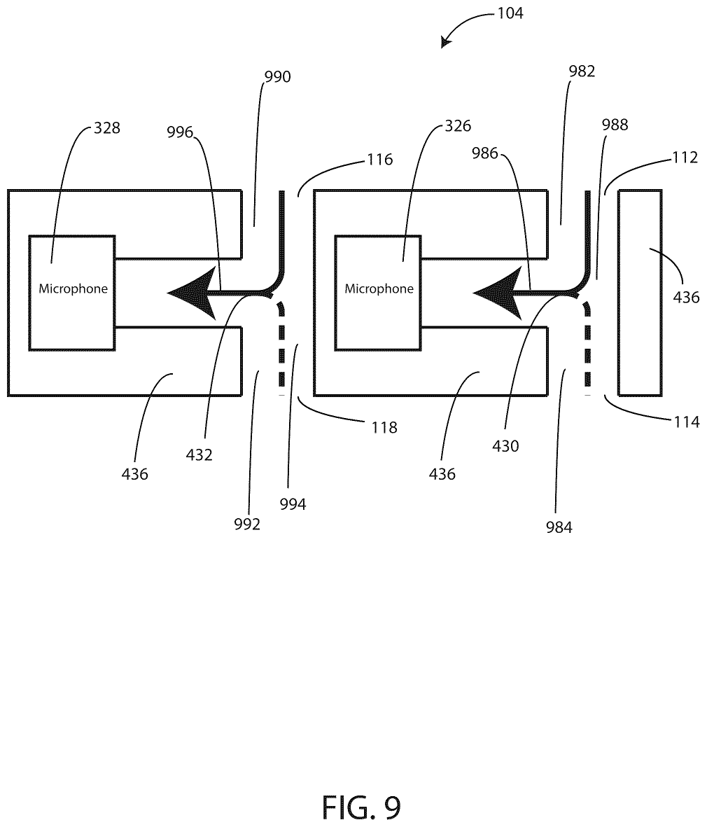

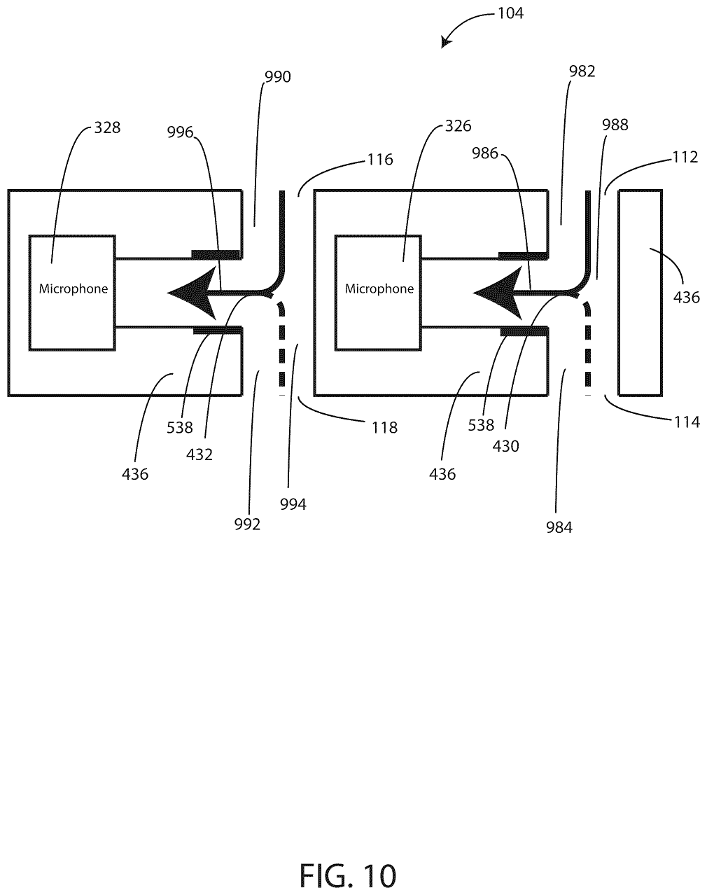

As shown in FIG. 4, as well as depicted in FIGS. 9-10, two inlets can form a pass-through channel, such as a channel that extends from a left housing inlet to a right housing inlet. The pass-through channel can provide access to easily clean or remove debris from a portion of the acoustic channel. In some embodiments, the pass-through channel can be linear or straight, such as to facility a cleaning utensil, such as a brush or cotton swab, to be inserted through the pass-through channel thereby removing debris that was disposed within the pass-through channel.

The microphone module 104 can be mechanically coupled to the body module 106 through a connection element 434. In some embodiments, the connection element 434 can be selected from the group consisting of a snap fit, a compression fit, and a mechanical fastener. In various embodiments, the microphone module 104 includes only one mechanical connector to secure the microphone module to the body module. In various embodiments, the microphone module 104 includes two mechanical connectors to secure the microphone module to the body module. In various embodiments, the microphone module 104 includes three or more mechanical connectors to secure the microphone module to the body module.

In various embodiments, the microphone module 104 can include a base structure 436, such as a microphone module case. The base structure 436 can include a polymer. In various embodiments, the base structure 436 can provide a structure for components to be coupled to. In various embodiments, the base structure 436 can define some components, such as the connection element 434. In some embodiments, the base structure 436 can define at least a portion of some components, such as the acoustic channels 430, 432. The base structure 436 can define the inlets 112, 114, 116, 118. In various embodiments, the base structure 436 is constructed from a rigid material with sufficient rigidity to hold the components of the microphone module in a fixed relationship to each other and create and maintain the acoustic passages.

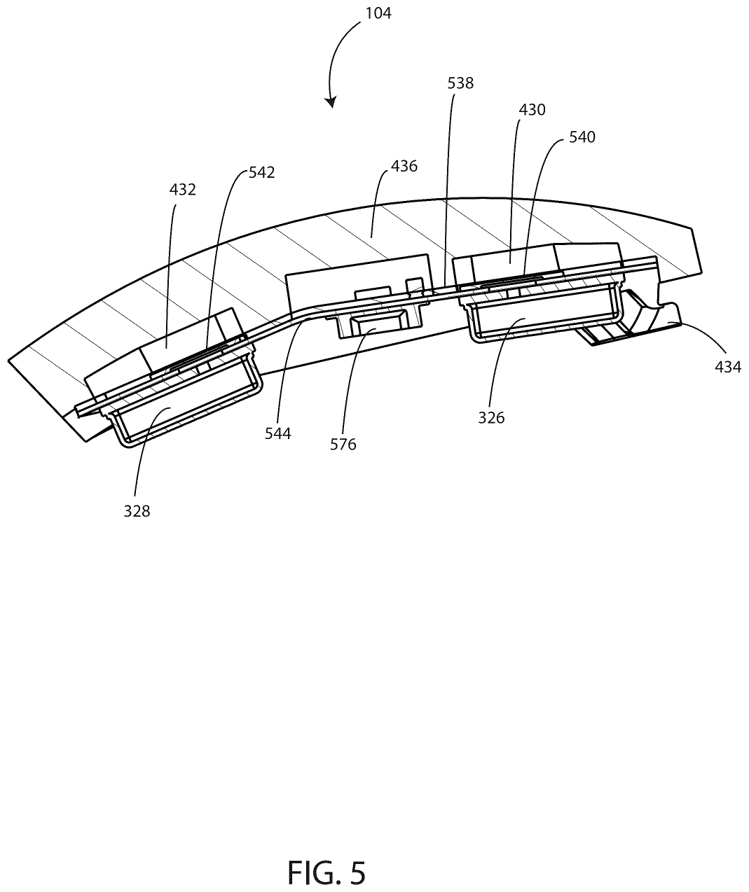

Referring now to FIG. 5, a cross-section view of a microphone module 104 is shown in accordance with various embodiments herein. The microphone module 104 can include a front microphone 326 and a back microphone 328. The microphone module 104 can define a first acoustic channel 430 extending from at least one inlet 112, 114, 116, 118 to one of the microphones 326, 328. In some embodiments, the first acoustic channel 430 extends from one front inlet 112, 114 to the front microphone 326. In some embodiments, the first acoustic channel 430 extends from the front inlets 112, 114 to the front microphone 326.

The microphone module 104 can define a second acoustic channel 432 extending from at least one inlet 112, 114, 116, 118 to one of the microphones 326, 328. In some embodiments, the second acoustic channel 432 extends from one back inlet 116, 118 to the back microphone 328. In some embodiments, the second acoustic channel 432 extends from the back inlets 116, 118 to the back microphone 328.

In various embodiments, an acoustic channel 430, 432 can extend from an inlet 112, 114, 116, 118. The acoustic channel 430, 432 can proceed to extend through a portion of the base structure 436. The acoustic channel 430, 432 can proceed to extend through a gasket 538, a mesh layer 540, 542, and a circuit board 544 and to a microphone 326, 328.

FIG. 5 further shows connector 576. In various embodiments, the connector 576 can provide electrical communication between the microphone module 104 and the body module 106 when the microphone module 104 is coupled to the body module 106, and can be referred to as an electrical connector. In various embodiments, the connector 576 can extend away from the base structure 436 and towards the body module 106. The connector 576 can be a projection from the circuit board 544 in the direction of the body module. The connector 576 can include one or more electrical contacts that align with electrical contacts in the body module 106.

In various embodiments, the connector 576 can also provide a mechanical connection between the microphone module 104 and the body module 106. In various embodiments, the connector 576 and the connection element 434 can cooperate to mechanically couple the microphone module 104 with the body module 106.

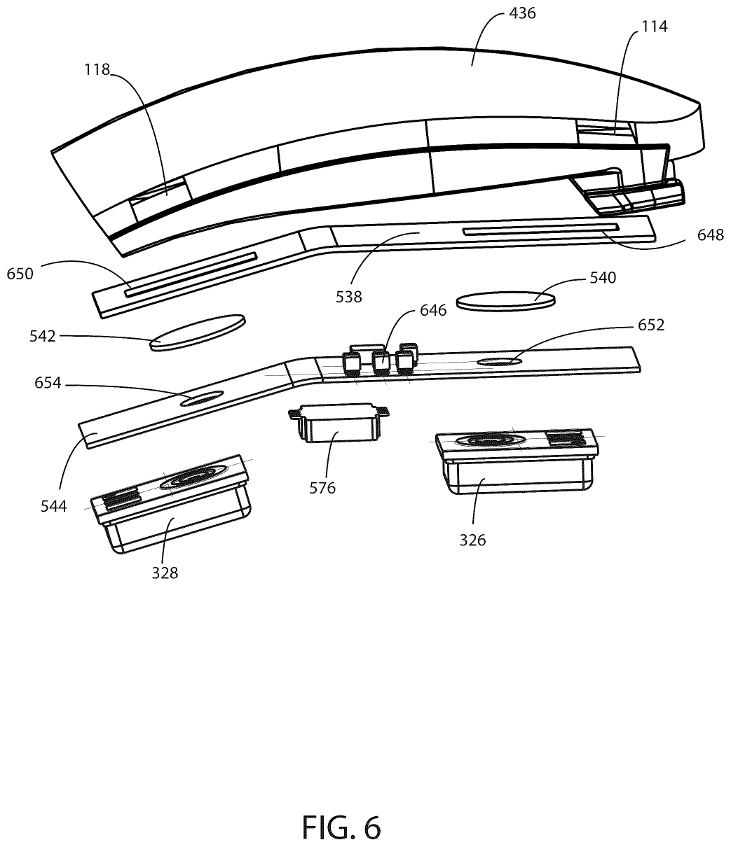

In reference now to FIG. 6, an exploded view of the microphone module 104 is shown in accordance with various embodiments herein. As discussed above, the microphone module 104 can include a base structure 436, a gasket 538, a mesh layer 540, 542, a circuit board 544, and at least one microphone 326, 328.

In some embodiments, the gasket 538 can define at least one aperture for an acoustic channel to extend through. In some embodiments, the gasket 538 defines a front aperture 648 defining a portion of the first acoustic channel 430 and a back aperture 650 defining a portion of the second acoustic channel 432. In various embodiments, two separate gasket structures are provided in place of a single gasket 538, where one gasket surrounds a portion of each acoustic channel.

The gasket 538 can be formed from any number of suitable materials. In some embodiments, the gasket 538 can be formed from a material configured to conform to the surrounding structures such as base structure 436. In some embodiments, the gasket 538 can be formed from a polymer or foam. The gasket 538 may be cut from a sheet of foam or other material and may include a pressure sensitive adhesive to connect the gasket 538 to the circuit board 544 or the base structure 436.

In various embodiments, the microphone module 104 can include a front mesh layer 540 covering a portion of the circuit board 544 and a front microphone port 652. The microphone module 104 can include a back mesh layer 542 covering a portion of the circuit board 544 and a back microphone port 654. In some embodiments, the front mesh layer 540 can be separated from the back mesh layer 542, such as shown in FIG. 6. In some embodiments, the front mesh layer 540 and the back mesh layer 542 are a continuous single component.

In various embodiments, the mesh layer 540, 542 can be disposed within an acoustic channel 430, 432. In some embodiments, the front mesh layer 540 is disposed within the first acoustic channel 430, such that the first acoustic channel 430 extends through the front mesh layer 540. Similarly, in some embodiments, the back mesh layer 542 is disposed within the second acoustic channel 432, such that the second acoustic channel 432 extends through the back mesh layer 542.

The mesh layer 540, 542 can be any suitable material or materials that is permeable to gasses and impermeable to solids and liquids. In some embodiments, the mesh layer can be a very fine mesh. Examples of appropriate mesh layers are sold by Saati S.p.A. of Vilano, Italy, under the tradename Acoustex, including SAATI Nanomesh AETHEX™ material or the like. While not intending to be bound by theory, it is believed that including a mesh layer over the microphone inlet can increase the lifespan of the microphone by preventing debris (e.g., earwax, water, oils) from entering the microphone port 652, 654 and contaminating the microphone 326, 328.

In various embodiments, the circuit board 544 can be a flexible circuit board. In various embodiments, one or more electrical components can be coupled to the circuit board. In some embodiments, the circuit board 544 can include a connector that can interface with and electrically couple the circuit board 544 with electrical components within the body module 106 when the microphone module 104 is coupled with the body module 106.

In some embodiments, a memory component 646 can be coupled to the circuit board 544. The memory component 646 can be disposed within the microphone module 104. In various embodiments, the memory component 646 can include non-volatile memory, such as a chip or device, such that settings or other data can be saved within the microphone module 104 without requiring an additional power source. In some embodiments, the microphone module does not include a power source, such as a battery.

In some embodiments, microphone performance or response data can be encoded onto the memory component 646. In various embodiments, the microphone module can be configured to store microphone calibration data, such as sensitivity and other data, on the memory component 646. In various embodiments, the memory component 646 can store the data specified in the Transducer Electronic Data Sheet (TEDS) method, defined by IEEE 1451, or other standards, using an EEPROM or a similar component.

Data from the memory component can be relayed to the body module 106, which can then optimize the performance of the hearing air assembly's output to account for the exact response of the attached microphone module. In some embodiments, this configuration could, not only provide better performance or response of the overall sound for users but could also more easily accommodate changing, such as upgrading, microphone models without needing extensive changes to hearing aid mechanics or firmware.

In various embodiments, the circuit board 544 can define one or more apertures, such as an aperture for each acoustic channel. In some embodiments, the circuit board 544 can define a first aperture or front microphone port 652 and a back aperture or back microphone port 654. In some embodiments, the front microphone port 652 can define a portion of the first acoustic channel 430 and align with the front microphone 326. In some embodiments, the back microphone port 654 can define a portion of the second acoustic channel 432 and align with the back microphone 328.

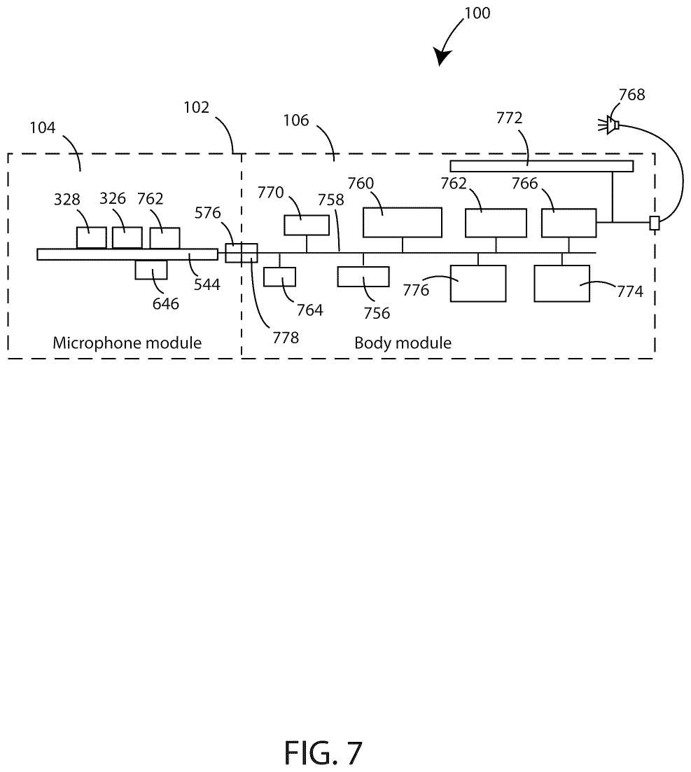

Referring now to FIG. 7, a schematic block diagram is shown with various components of an ear-worn device in accordance with various embodiments. The block diagram of FIG. 7 represents a hearing assistance device for purposes of illustration. The ear-worn device 100 shown in FIG. 7 includes several components electrically connected to each other, such as by electrically connecting a circuit board 544 (e.g., flexible mother board) which is disposed within the microphone module 104 with a circuit board 758 (e.g. flexible circuit board) which is disposed within the body module 106 via a connector 576. The connector 576 can electrically couple the electronics disposed within the body module 106 with the electronics disposed within the microphone module 104.

Although a single circuit board 544 is shown in the microphone module 104 and a single circuit board 758 is shown in the body module 106 in schematic view of FIG. 7, in various embodiments, the components illustrated in FIG. 7 may be connected to two or more circuit boards (e.g., flexible circuit boards) in one or both of the microphone module and the body module.

A power supply circuit 756 can include a battery (e.g., battery 330) and can be electrically connected to a circuit board 758 disposed within the body module 106. The power supply circuit 756 can provide power to the various components of the ear-worn device 100.

One or more microphones 326, 328 can be electrically connected to the circuit board 544, which provides electrical communication between the microphones 326, 328 and a digital signal processor (DSP) 760 when the microphone module 104 is connected with the body module 106. Among other components, the DSP 760 incorporates or is coupled to audio signal processing circuitry configured to implement various functions described herein. A sensor package 762 can be coupled to the DSP 760 via the circuit board 758. The sensor package 762 can include one or more different specific types of sensors such as an accelerometer. One or more user switches 764 (e.g., on/off, volume, mic directional settings) are electrically coupled to the DSP 760 via the circuit board 758. The one or more switches 764 can be linked with the user input device 108.

An audio output device 766 is operatively connected to the DSP 760 via the circuit board 758. In some embodiments, the audio output device 766 comprises a speaker (coupled to an amplifier). In other embodiments, the audio output device 766 comprises an amplifier coupled to an external receiver 768 adapted for positioning within an ear of a wearer. The external receiver 768 can include a transducer, speaker, or loudspeaker. In various embodiments, the external receiver 768 can be positioned within the earbud 120 of FIG. 1 and connected with the remainder of the hearing assistance device via the cable 122 of FIG. 1. It will be appreciated that external receiver 768 may, in some embodiments, be an electrode array transducer associated with a cochlear implant or brainstem implant device. The ear-worn device 100 may incorporate a communication device 770 coupled to the circuit board 758 and to an antenna 772 directly or indirectly via the circuit board 758. The communication device 770 can be a Bluetooth® transceiver, such as a BLE (Bluetooth® low energy) transceiver or another transceiver (e.g., an IEEE 802.11 compliant device). The communication device 770 can be configured to communicate with one or more external devices in accordance with various embodiments. In various embodiments, the communication device 770 can be configured to communicate with an external visual display device such as a smart phone, a video display screen, a tablet, a computer, or the like.

In various embodiments, the ear-worn device 100 can also include a control circuit 774 and a memory storage device 776. The control circuit 774 can be in electrical communication with other components of the device. The control circuit 774 can execute various operations. The control circuit 774 can include various components including, but not limited to, a microprocessor, a microcontroller, an FPGA (field-programmable gate array) processing device, an ASIC (application specific integrated circuit), or the like. The memory storage device 776 can include both volatile and non-volatile memory. The memory storage device 776 can include ROM, RAM, flash memory, EEPROM, SSD devices, NAND chips, and the like. The memory storage device 776 can be used to store data from sensors and/or processed data generated using data from sensors.

In various embodiments, one or more of the following components are housed in the body module 106 and are not housed in the microphone module 104: battery 330, sensors 762, communication device 770, an inertial measurement unit, and user input devices 108. In various embodiments, the body module 106 can include a GMR sensor, a telecoil, an accelerometer, or an inertial measurement unit. In other embodiments, the microphone module can include a GMR sensor, a telecoil, an accelerometer, or an inertial measurement unit.

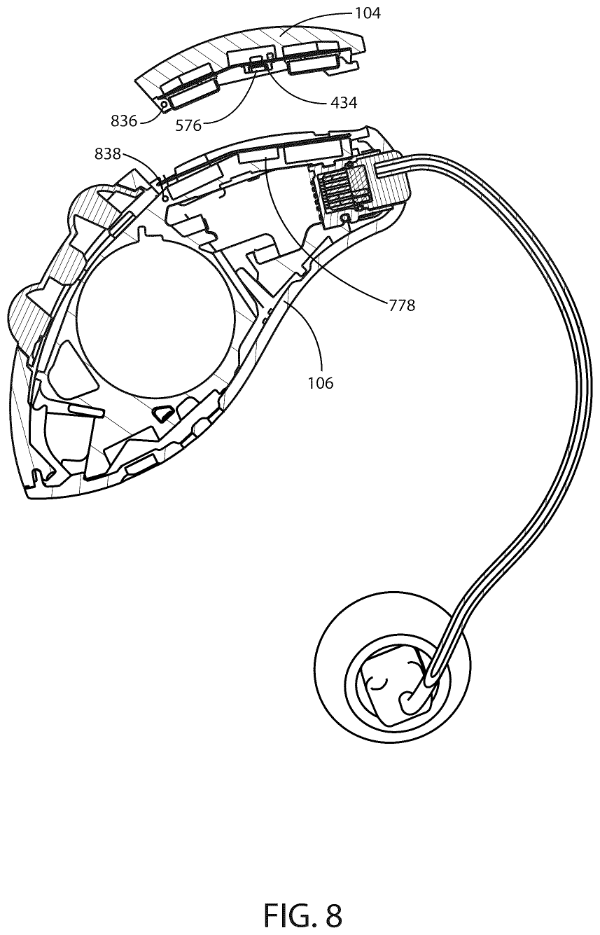

Referring now to FIG. 8, a cross-sectional, exploded view of an ear-worn device is shown in accordance with various embodiments herein. The example of an ear-worn device shown in FIG. 8 includes the microphone module 104 uncoupled from the body module 106.

In some embodiments, the microphone module 104 can include a connection element 434 for physically coupling the microphone module 104 and the body module 106. When the microphone module 104 and the body module 106 are physically coupled together, they can be rigid, such that one component cannot move separately from the other component.

In some embodiments, the microphone module 104 can include a connector 576 for electrical communication between the microphone module 104 and the body module 106. The microphone module 104 can include a connector 576 for electrically coupling the flexible circuit board 544 with an electronics package disposed within the body module 106, such as the circuit board 758. In various embodiments, the electronics package within the body module 106 can include one or more of: a communication device 770, switches 764, a power supply 756, DSP 760, sensor package 762, audio output device 766, memory device 776, control circuit 774, and antenna 772 as discussed above.

The connector 576 can interface with a connector 778 of the body module 106 to couple the microphone module 104 with the body module 106. The connector 778 of the body module 106 can include the necessary components to physically and/or electrically couple the microphone module 104 with the body module 106. Upon electrically connecting the microphone module 104 with the body module 106, data, power, control signals, and other electrical communications can be transmitted between the two modules 104, 106. In some embodiments, the connector 576 can be rigidly attached to microphone module 104. In some embodiments, the connector 576 can be attached to the rest of the microphone module 104 via a flexible connection.

As shown in FIG. 8, in some embodiments, the connector 576 can be incorporated into the connection element 434, such that physically coupling the microphone module 104 with the body module also electrically connects the microphone module 104 with the body module 106.

In various embodiments, a mechanical connector can couple the microphone module 104 with the body module 106. In some embodiments, a pin can be inserted through aperture 836 defined by the microphone module 104 and aperture 838 defined by the body module 10 thereby coupling the body module 106 with the microphone module 104.

### Acoustic Paths and Ingress Protection

In reference now to FIGS. 9 and 10, schematics of acoustic paths within an ear-worn device 100 are shown in accordance with various embodiments herein. In various embodiments, the microphone module 104 can include various elements for ingress protection. In some embodiments, various components can be nanocoated in the subassembly for better coverage enhancing the effectiveness of the ingress protection. In various embodiments, the microphone module 104 can include wax traps or tortuous pathways for ingress protection. In some embodiments, meshes, grids, or other mechanical or physical barriers can be included for ingress protection.

FIG. 9 shows a schematic of the acoustic paths within a microphone module 104. The microphone module 104 defines at least one inlet. In the example of FIG. 9, four inlets 112, 114, 116, 118 are shown. In various embodiments, the first housing inlet 112 and the second housing inlet 114 define a pass-through channel 988 in the microphone module 104. The pass-through channel 988 can include a first inlet channel 982 and a second inlet channel 984. The first acoustic channel 430 can include the pass-through channel 988.

In various embodiments, a combined path channel 986, such as where the first inlet channel 982 and the second inlet channel 984 combine, extends substantially perpendicular to the pass-through channel 988. The pass-through channel 988 can prevent debris from entering the combined path channel 986. The pass-through channel 988 can also facilitate easy cleaning as discussed above.

In various embodiments, the third housing inlet 116 and the fourth housing inlet 118 define a second pass-through channel 994 in the microphone module 104. The pass-through channel 994 can include a third inlet channel 990 and a fourth inlet channel 992. The second acoustic channel 432 can include the pass-through channel 994.

In various embodiments, a combined path channel 996, such as where the third inlet channel 990 and the fourth inlet channel 992 combine, extends substantially perpendicular to the pass-through channel 994. The pass-through channel 994 can prevent debris from entering the combined path channel 996. The pass-through channel 994 can also facilitate easy cleaning as discussed above.

In various embodiments, the entire first acoustic channel 430 is defined by the base structure 436, such as shown in FIG. 9. In some embodiments, a portion of the first acoustic channel 430 is defined by the base structure 436, and a portion is defined by other components, such as the gasket 538, as shown in FIG. 10. In some embodiments, portions of one or more acoustic channels are defined between the body module 106 and the base structure 436 of the microphone module 104, such as portions of the acoustic channel near one or more of the inlets.

### Methods

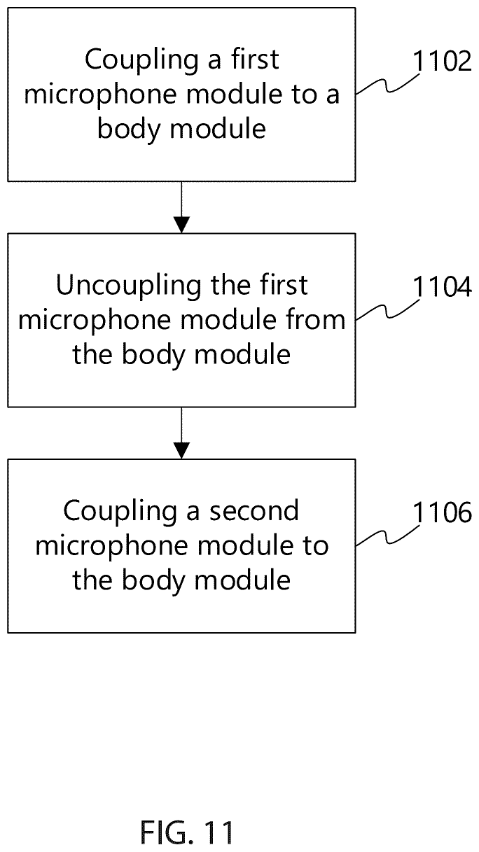

Referring now to FIG. 11, a flow chart depicting a method is shown in accordance with various embodiments herein.

In various embodiments, the method can include coupling a first microphone module to a body module 1102. In some embodiments, the coupling can be via a removeable coupling and can form or assemble a housing. In some embodiments, the first microphone module comprises a first microphone adjacent to a first microphone port, and the first microphone module defines a first housing inlet and a first acoustic channel having a first end at the first housing inlet and a second end at the first microphone port.

In various embodiments, the method can further include uncoupling the first microphone module from the body module 1104. In various embodiments, the method can further include coupling a second microphone module to the body module 1106. In some embodiments, the coupling can be via a removeable coupling and can form or assemble the housing. In various embodiments, the second microphone module is identical to the first microphone module, such that it has the same size, shape, features, and configuration. In various embodiments, the second microphone module is different from the first microphone module in at least one of size, shape, features, and configuration. In some embodiments, the second microphone module can have different or additional functions compared to the first microphone module. In some embodiments, the second microphone module can include additional electronic components to facilitate the additional functions.

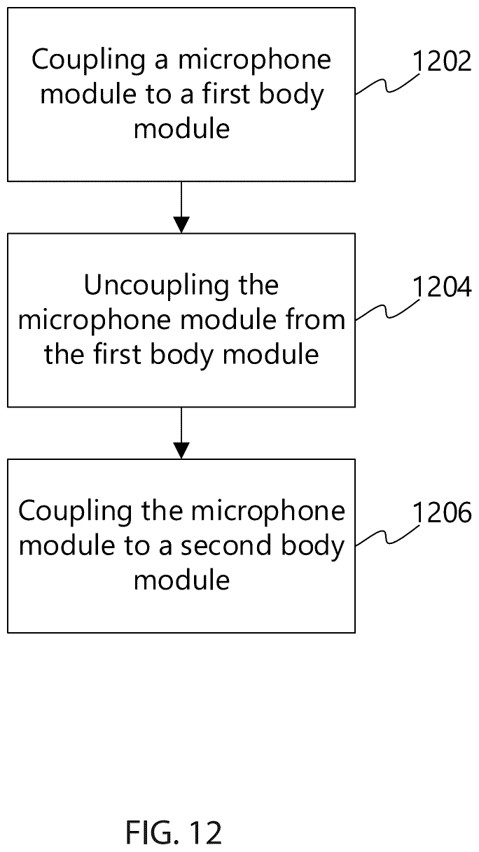

Referring now to FIG. 12, a flow chart depicting a method is shown in accordance with various embodiments herein. In various embodiments, the method can include coupling a microphone module to a first body module 1202. In some embodiments, the coupling can be via a removeable coupling and can form or assemble a housing. In some embodiments, the first microphone module comprises a first microphone adjacent to a first microphone port, and the first microphone module defines a first housing inlet and a first acoustic channel having a first end at the first housing inlet and a second end at the first microphone port.

In various embodiments, the method can further include uncoupling the microphone module from the first body module 1204. In various embodiments, the method can further include coupling the microphone module to a second body module 1206. In some embodiments, the coupling can be via a removeable coupling and can form or assemble the housing. In various embodiments, the microphone module can “click” together with the body module, such as with a snap fit. The microphone module can be mechanically fixed with the body module until a user intends for the modules to be uncoupled. In various embodiments, the second body module is identical to the first body module, such that it has the same size, shape, features, and configuration. In various embodiments, the second body module is different from the first body module in at least one of size, shape, features, and configuration.

In some embodiments, the second body module can have different or additional functions compared to the first body module. In some embodiments, the second body module can include additional electronic components to facilitate the additional functions.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An ear-worn device, comprising:
a housing comprising a microphone module and a body module;
wherein the microphone module comprises a first microphone adjacent to a first microphone port;
wherein the microphone module defines a first housing inlet and a first acoustic channel having a first end at the first housing inlet and a second end at the first microphone port;
wherein the microphone module is removably coupled to the body module.

2. The ear-worn device of claim 1, wherein the microphone module further defines a second housing inlet,
wherein the first housing inlet and the second housing inlet define a pass-through channel in the microphone module,
wherein the pass-through channel comprises a first inlet channel and a second inlet channel, and
wherein the pass-through channel is a portion of the first acoustic channel.

3. The ear-worn device of claim 2, wherein the first acoustic channel comprises a combined path channel that extends substantially perpendicular to the pass-through channel.

4. The ear-worn device of claim 1, wherein the first acoustic channel is defined entirely within the microphone module.

5. The ear-worn device of claim 1, wherein at least a portion of the first acoustic channel is defined by the microphone module from the first inlet opening to the first microphone port,
wherein a second portion of the first acoustic channel is defined by the body module.

6. The ear-worn device of claim 1, wherein the microphone module comprises a microphone module case, and wherein the first acoustic channel is defined entirely by the microphone module case.

7. The ear-worn device of claim 1, wherein the microphone module comprises a microphone module case and a gasket disposed within the microphone module case, wherein the first acoustic channel is defined by the microphone module case and the gasket.

8. The ear-worn device of claim 1, wherein the microphone module further comprises a circuit board, wherein the first microphone is coupled to the circuit board.

9. The ear-worn device of claim 8, wherein the microphone module further comprises a connector electrically coupling the circuit board with an electronics package disposed within the body module.

10. The ear-worn device of claim 9, wherein the connector is rigidly attached to the microphone module.

11. The ear-worn device of claim 10, wherein the microphone module is removably coupled with the body module via the connector, such that the connecter interfaces with a component of the body module.

12. The ear-worn device of claim 8, further comprising a non-volatile memory element coupled to the circuit board.

13. The ear-worn device of claim 2, the microphone module further comprises a second microphone adjacent to a second microphone port, and
wherein the microphone module defines a third housing inlet, a fourth housing inlet and a second acoustic channel extending from the third housing inlet and the fourth housing inlet to the second microphone port.

14. The ear-worn device of claim 13,
wherein the third housing inlet and the fourth housing inlet define a second pass-through channel in the microphone module,
wherein the second pass-through channel comprises a third inlet channel and a fourth inlet channel, and
wherein the second pass-through channel is a portion of the second acoustic channel.

15. The ear-worn device of claim 14, wherein the first pass-through channel and the second pass-through channel are both substantially straight/linear;
wherein the first acoustic channel comprises a combined path channel that extends substantially perpendicular to the first pass-through channel; and
wherein the second acoustic channel comprises a combined path channel that extends substantially perpendicular to the second pass-through channel.

16. The ear-worn device of claim 1, wherein the microphone module is removably coupled with the body module via a connection selected from the group consisting of a snap fit, a compression fit, and a mechanical fastener.

17. An ear-worn device system, comprising:
a housing comprising:
a first microphone module, and
a body module;
wherein the first microphone module comprises a first microphone adjacent to a first microphone port;
wherein the first microphone module defines a first housing inlet and a first acoustic channel having a first end at the first housing inlet and a second end at the first microphone port; wherein the first microphone module is removably coupled to the body module;
a second microphone module, wherein the second microphone module comprises a first microphone adjacent to a first microphone port; wherein the second microphone module defines a first housing inlet and a second acoustic channel having a first end at the first housing inlet and a second end at the first microphone port, wherein the second microphone module is configured to be removably coupled to the body module to replace the first microphone module.

18. A method of assembling an ear-worn device, comprising:
coupling a first microphone module to a body module via a removeable coupling to assemble a housing; wherein the first microphone module comprises a first microphone adjacent to a first microphone port, wherein the first microphone module defines a first housing inlet and a first acoustic channel having a first end at the first housing inlet and a second end at the first microphone port,
uncoupling the first microphone module from the body module, and
coupling a second microphone module to the body module via a removeable coupling to assemble the housing; wherein the second microphone module comprises a first microphone adjacent to a first microphone port, wherein the second microphone module defines a first housing inlet and a first acoustic channel having a first end at the first housing inlet and a second end at the first microphone port.

19. The method of assembling the ear-worn device according to claim 18, wherein the second microphone module comprises at least one element that the first microphone module does not, wherein the at least one element is selected from the group comprising: a telecoil, an accelerometer, an inertial measurement unit, and a sensor.

20. The method of assembling the ear-worn device according to claim 18, wherein the second microphone module comprises a function set that is identical to a function set of the first microphone module.
